(19) United States
(12) Patent Application Publication
(10) Pub. No.: US 2017/0249561 A1
(43) Pub. Date: Aug. 31, 2017

(54) ROBOT LEARNING VIA HUMAN-DEMONSTRATION OF TASKS WITH FORCE AND POSITION OBJECTIVES

(71) Applicant: GM GLOBAL TECHNOLOGY OPERATIONS LLC, Detroit, MI (US)

(72) Inventor: Muhammad E. Abdallah, Rochester Hills, MI (US)

(73) Assignee: GM GLOBAL TECHNOLOGY OPERATIONS LLC, Detroit, MI (US)

(21) Appl. No.: 15/056,232

(22) Filed: Feb. 29, 2016

(51) Int. Cl. G06N 99/00; G06K 7/10

(52) U.S. Cl. CPC G06N 99/005; G06K 7/10366

(57) ABSTRACT

A system for demonstrating a task to a robot includes a glove, sensors, and a controller. The sensors measure task characteristics while a human operator wears the glove and demonstrates the task. The task characteristics include a pose, joint angle configuration, and distributed force of the glove. The controller receives the task characteristics and uses machine learning logic to learn and record the demonstrated task as a task application file. The controller transmits control signals to the robot to cause the robot to automatically perform the demonstrated task. A method includes measuring the task characteristics using the glove, transmitting the task characteristics to the controller, processing the task characteristics using the machine learning logic, generating the control signals, and transmitting the control signals to the robot to cause the robot to automatically execute the task.

### TECHNICAL FIELD

The present disclosure relates to human-demonstrated learning of robotic applications, particularly those having force and position objectives.

### BACKGROUND

Serial robots are electro-mechanical devices that are able to manipulate objects using a series of robotic links. The robotic links are interconnected by robotic joints, each of which is driven by one or more joint actuators. Each robotic joint in turn represents an independent control variable or degree of freedom. End-effectors disposed at the distal end of the serial robot are configured to perform a particular task, such as grasping a work tool or stacking multiple components. Typically, serial robots are controlled to a desired target value via closed-loop force, velocity, impedance, or position-based control laws.

In manufacturing, there is a need for flexible factories and processes that are able to produce new or more varied products with a minimum amount of downtime. To fully accomplish this goal, robotic platforms are required to quickly adapt to new tasks without time consuming reprogramming and code compilation. Traditionally, robots are programmed manually by coding the behavior in a programming language or through a teach pendent with pull-down menus. As the complexity of both the robot and the application increase, such traditional techniques have become unduly complex and time consuming. Therefore, an attempt to develop programs in a simpler, more intuitive way has developed known generally as “learning by demonstration” or “imitation learning”.

Using such methods, a human operator performs a task and a computer system learns the task by observing through the use of machine-learning techniques. Training operations are typically performed either by a human operator directly performing the task while a computer vision system records behaviors, or by the operator gripping the robot and physically moving it through a required sequence of motions. Such “learning by demonstration” techniques have the potential to simplify the effort of programming robotic applications with increased complexity. Robotic tasks typically have position or motion objectives that define the task. More so, these types of tasks have started to incorporate force or impedance objectives, i.e., objectives that specify the level of forces to be applied. When a task also requires force objectives, the use of position capture data alone is no longer sufficient. As a result, systems have evolved that attempt to learn such tasks by adding force sensors to the robot as the robot is moved or backdriven through a task demonstration. However, existing approaches may remain less than optimal for demonstration of certain types of dexterous tasks having both force and position objectives.

### SUMMARY

A system and accompanying method are disclosed herein for facilitating robotic learning of human operator-demonstrated applications having force and position objectives. The present approach is intended to greatly simplify development of complex robotic applications, particularly those used in unstructured environments and/or environments in which direct human-robot interaction and collaboration occurs. Unstructured environments, as is known in the art, are work environments that are not heavily configured and designed for a specific application. As the complexity of robots continues to increase, so too does the complexity of the types of robotic tasks that can be performed. For instance, some emerging robots use tendon-actuated fingers and opposable thumbs to perform tasks with human-like levels of dexterity and nimbleness. Traditional task programming and conventional backdriving task demonstration for such robots is thus complex to the point of being impracticable.

In an example embodiment, a system for demonstrating to a robot a task having both force and position objectives includes a glove that is wearable by a human operator. The system also includes sensors and one or more controllers, with the controller(s) in communication with the sensors. The sensors collectively measure task characteristics while the human operator wearing the glove actively demonstrates the task solely through the human operator's actions. The task characteristics include distributed forces acting on the glove, as well as a glove pose and joint angle configuration.

The controller may be programmed to apply machine learning logic to the task characteristics to thereby learn and record the demonstrated task as a task application file. The controller is also programmed to execute the task application file and thereby control an operation of the robot, i.e., the robot automatically executes the task that was initially demonstrated by the human operator wearing the glove.

A method is also disclosed for demonstrating a task to a robot using a glove on which is positioned the sensors noted above. The method may include measuring the set of task characteristics using the glove while a human operator wears the glove and demonstrates the task, and then transmitting the task characteristics to a controller. The method may include processing the task characteristics via the controller using machine learning logic to thereby learn and record the demonstrated task as a task application file and generating a set of control signals using the task application file. The set of control signals is transmitted to the robot to thereby cause the robot to automatically perform the demonstrated task.

The above features and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic illustration of an example glove usable as part of a system for demonstrating a force-position task to a robot as set forth herein.

FIG. 2 is a schematic illustration of the palm-side of the glove shown in FIG. 1.

FIG. 3 is a schematic illustration of a system for demonstrating and executing a force-position task to a robot using the glove of FIGS. 1 and 2.

FIG. 4 is a flow chart describing an example method for demonstrating a force-position task to a robot using the system shown in FIG. 4.

### DETAILED DESCRIPTION

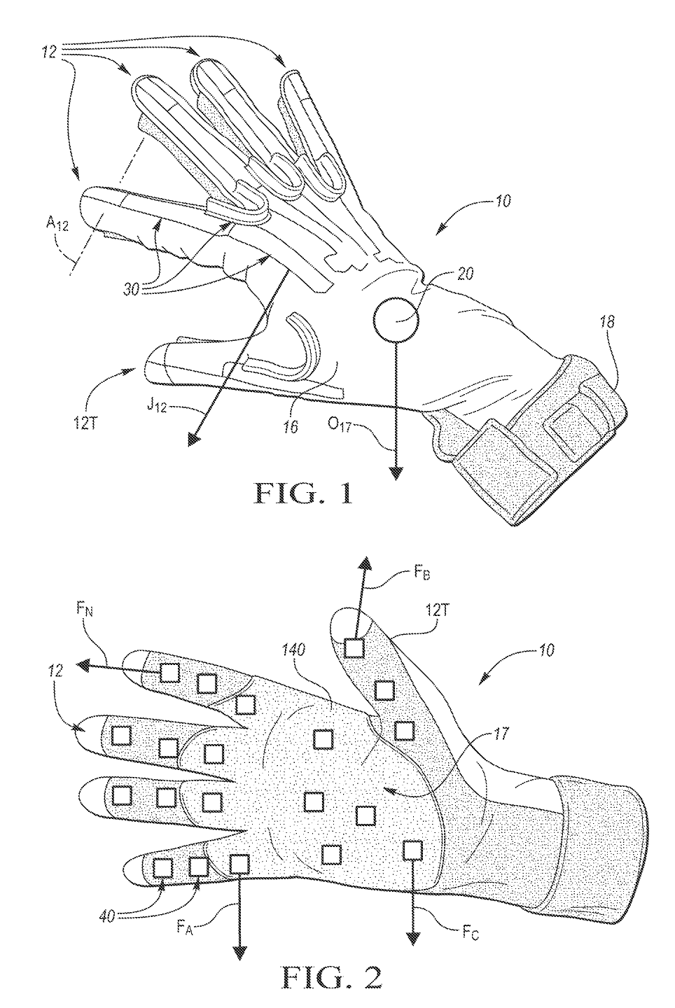

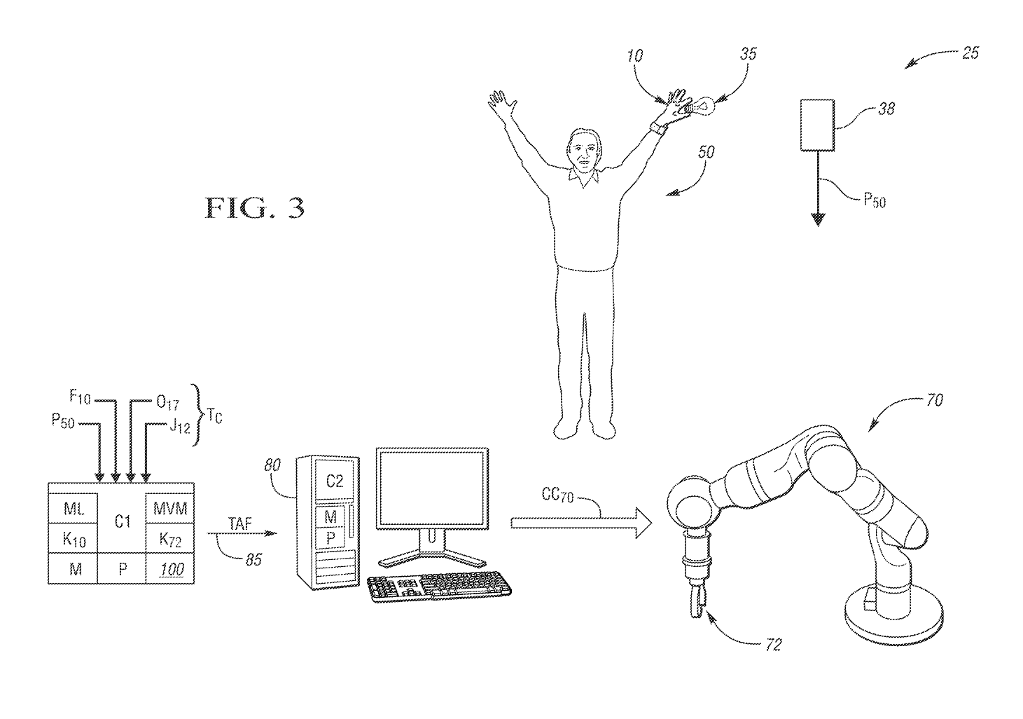

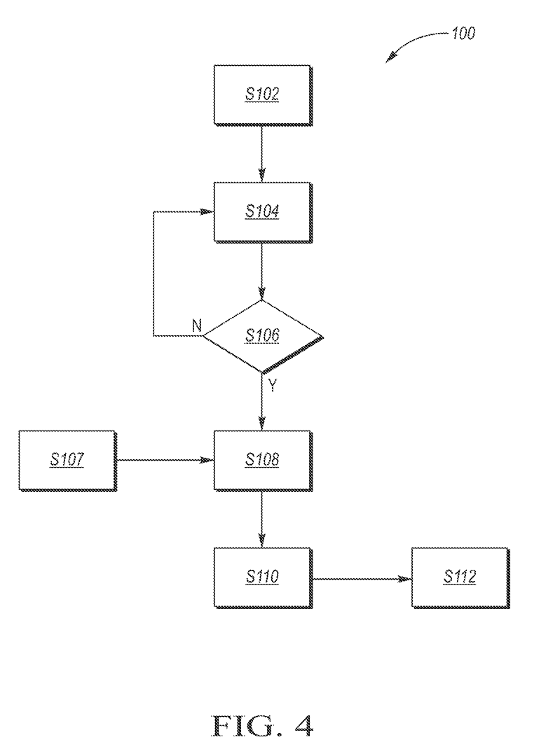

Referring to the drawings, wherein like reference numbers correspond to like or similar components throughout the several figures, a glove 10 is shown schematically in FIGS. 1 and 2 according to an example embodiment. As shown in FIG. 3, the glove 10 is configured to be worn by a human operator 50 as part of a system 25 in the demonstration to a robot 70 of a task having both force and position objectives. The system 25 of FIG. 3 is controlled according to a method 100, an embodiment of which is described below with reference to FIG. 4.

With respect to the glove 10 shown in FIGS. 1 and 2, the glove may include a plurality of jointed or articulated fingers 12 and an optional jointed or articulated opposable thumb 12T. The glove 10 also includes a back 16 and a palm 17. The glove 10 may be constructed of any suitable material, such as breathable mesh, nylon, and/or leather. An optional wrist strap 18 may be used to help secure the glove 10 to a wrist of the operator 50 shown in FIG. 3. While four fingers 12 and an opposable thumb 12T are shown in the example embodiment of FIGS. 1 and 2, other configurations of the glove 10 may be readily envisioned, such as a two-finger or a three-finger configuration suitable for pinching-type grasping applications.

Unlike conventional methodologies using vision systems to determine position and teach pendants to drive a robot during a given task demonstration, the present approach instead allows the human operator 50 to perform a dexterous task directly, i.e., by the human operator 50 acting alone without any involvement of the robot 70 in the demonstration. As shown in FIG. 3, an example dexterous task may include that of grasping, inserting, and rotating a light bulb 35 into a threaded socket (not shown). Such a task involves closely monitoring and controlling a number of dynamically changing variables collectively describing precisely how to initially grasp the light bulb 35, how hard and quickly to insert the light bulb 35 into the socket while still grasping the light bulb 35, how rapidly the light bulb 35 should be threaded into the socket, and how much feedback force should be detected to indicate that the light bulb 35 has been fully threaded into and seated within the socket. Such a task cannot be optimally learned using conventional robot-driven task demonstration solely using vision cameras and other conventional position sensors.

To address this challenge, the human operator 50 directly performs the task herein, with the demonstrated task having both force and position objectives as noted above. In order to accomplish the desired ends, the glove 10 may be equipped with a plurality of different sensors, including at least a palm pose sensor 20, joint configuration sensors 30, and an array of force sensors 40, all of which are arranged on the palm 17, fingers 12, and thumb 12T as shown in FIGS. 1 and 2. The sensors 20, 30, and 40 are in communication with one or more controllers, including, in an example embodiment, a first controller (C1) 60. The sensors 20, 30, and 40 are configured to collectively measure task characteristics (TC) while the human operator 50 wearing the glove 10 directly demonstrates the task.

The task characteristics may include a distributed force (arrow F₁₀) on the glove 10 as determined using the array of the force sensors 40, as well as a palm pose (arrow O₁₇) determined via the palm pose sensor 20 and a joint angle configuration (arrow J₁₂) determined using the various joint configuration sensors 30. The first controller 60, which may be programmed with kinematics data (K₁₀) describing the kinematics of the glove 10, may processes the task characteristics and output a task application file (TAF) (arrow 85) to a second controller (C2) 80 prior to the control of the robot 70, as described in more detail later below. While first and second controllers 60 and 80 are described herein, a single controller or more than two controllers may be used in other embodiments.

With respect to the array of force sensors 40 shown in FIG. 2, each force sensor 40 may be embodied as load sensor of the type known in the art, for instance piezo-resistive sensors or pressure transducers. The force sensors 40 may be distributed on all likely contact surfaces of the palm 17, fingers 12, and thumb 12T of the glove 10 so as to accurately measure the collective forces acting on/exerted by the glove 10 at or along multiple points or surfaces of the glove 10 during the demonstrated task, and to ultimately determine the force distribution on the glove 10. Each of the force sensors 40 outputs a corresponding force signal, depicted as force signals F_{A}, F_{B}, . . . F_{N} in FIG. 2. The force sensors 40 can be of various sizes. For instance, a pressure sensor 140 in the form of a large area pressure mat may be envisioned in some embodiments.

The joint configuration sensors 30 of FIG. 1 are configured to measure the individual joint angles (arrow J₁₂) of the various joints of the fingers 12 and 12T. The joints each rotate about a respective joint axis (A₁₂), only one of which is indicated in FIG. 1 for illustrative simplicity. As is known in the art, a human finger has three joints, for a total of twelve joint axes, plus additional joint axes of the thumb 12T.

In an example embodiment, the joint configuration sensors 30 may be embodied as individual resolvers positioned at each joint, or as flexible strips as shown that are embedded in or connected to the material of the glove 10. The joint configuration sensors 30 determine a bending angle of each joint, and output the individual joint angles (arrow J₁₂) to the first controller 60 of FIG. 3. As is known in the art, such flexible sensors may be embodied as flexible conductive fibers or other flexible conductive sensors integrated into the flexible fabric of the glove 10, each having a variable resistance corresponding to a different joint angle of the glove 10. Measured changes in the resistance across the joint configuration sensors 30 related in memory (M) of the first controller 60 to specify a particular joint angle or combination of joint angles. Other joint configuration sensors 30 may include Hall effect sensors, optical sensors, or micro-electromechanical-system (MEMS) biaxial accelerometers and uniaxial gyroscopes within the intended inventive scope.

The palm pose sensor 20 of FIG. 1 may likewise be an inertial or magnetic sensor, a radio frequency identification (RFID) device, or other suitable local positioning device operable for determining the six degrees of freedom position and orientation or palm pose (arrow O₁₇) of the palm 17 in a three-dimensional space i.e., XYZ coordinates. The palm pose sensor 20 may be embedded in or connected to the material of the palm 17 or the back 16 in different embodiments. The sensors 20, 30, and 40 collectively measure the task characteristics 85 while the human operator 50 of FIG. 3 wears the glove 10 during direct demonstration of the task.

Referring to FIG. 3, the system 25 noted briefly above includes the glove 10 and the sensors 20, 30, and 40, as well the first and second controllers 60 and 80. The controllers 60 and 80 may be embodied as the same device, i.e., designated logic modules of an integrated control system, or they may be separate computing devices in communication with each other wirelessly or via transfer conductors. The first controller 60 receives the measured task characteristics from the sensors 20, 30, 40, i.e., the forces F₁₀, the palm pose O₁₇, and the joint configuration J₁₂.

Optionally, the system 25 may include a camera 38 operable for detecting a target, such as a position of the human operator 50 or the operator's hands, or an assembled or other object held by or proximate to the operator 50, during demonstration of the task and outputting the same as a position signal (arrow P₅₀), in which case the position signal (arrow P₅₀) may be received as part of the measured task characteristics. A machine vision module (MVM) can be used by the first controller 60 to determine position of the human operator 50 from the received position signal (arrow P₅₀) for such a purpose, e.g., by receiving an image file and determining the position via the machine vision module (MVM) using known image processing algorithms, as well as to determine a relative position of the glove 10 with respect to the human operator 50.

The first controller 60 can thereafter apply conventional machine learning techniques to the measured task characteristics using a machine learning (ML) logic module of the first controller 60 to thereby learn and record the demonstrated task as the task application file 85. The second controller 80 is programmed to receive the task application file 85 from the first controller 60 as machine-readable instructions, and to ultimately execute the task application file 85 and thereby control an operation of the robot 70 of FIG. 3.

The respective first and second controllers 60 and 80 may include such common elements as the processor (P) and memory (M), the latter including tangible, non-transitory memory devices or media such as read only memory, random access memory, optical memory, flash memory, electrically-programmable read-only memory, and the like. The first and second controllers 60 and 80 may also include any required logic circuitry including but not limited to proportional-integral-derivative control logic, a high-speed clock, analog-to-digital circuitry, digital-to-analog circuitry, a digital signal processor, and the necessary input/output devices and other signal conditioning and/or buffer circuitry. The term “module” as used herein, including the machine vision module (MVM) and the machine learning (ML) logic module, may be embodied as all necessary hardware and software needed for performing designated tasks.

Kinematics information K₇₂ of the end-effector 72 and kinematics information (K₁₀) of the glove 10 may be stored in memory M, such that the first controller 60 is able to calculate the relative positions and orientations of the human operator 50 and/or the glove 10 and a point in a workspace in which the task demonstration is taking place. As used herein, the term “kinematics” refers to the calibrated and thus known size, relative positions, configuration, motion trajectories, and range of motion limitations of a given device or object. Thus, by knowing precisely how the glove 10 is constructed and moves, and how the end-effector 72 likewise moves, the first controller 60 can translate the motion of the glove 10 into motion of the end-effector 72, and thereby compile the required machine-executable instructions.

With respect to machine learning in general, this term refers herein to the types of artificial intelligence that are well known in the art. Thus, the first controller 60 is programmed with the requisite data analysis logic for iteratively learning from and adapting to dynamic input data. For instance, the first controller 60 can perform such example operations as pattern detection and recognition, e.g., using supervised or unsupervised learning, Bayesian algorithms, clustering algorithms, decision tree algorithms, or neural networks. Ultimately, the machine learning module (ML) outputs the task application file 85, i.e., a computer-readable program or code that is executable by the robot 70 using the second controller 80. The second controller 80 ultimately outputs control signals (arrow CC₇₀) to the robot 70 to thereby cause the robot 70 to perform the demonstrated task as set forth in the task application file 85.

FIG. 4 depicts an example method 100 for demonstrating a task having force and position objectives to the robot 70 using the glove 10 of FIGS. 1 and 2. The method 100 begins with step S102, which entails demonstrating a robotic task, solely via human demonstration, using the glove 10 shown in FIGS. 1 and 2. The human operator 50 of FIG. 3 wears the glove 10 of FIGS. 1 and 2 on a hand and directly demonstrates the task using the gloved hand without any intervention or action by the end-effector 72 or the robot 70. The method 100 proceeds to step S104 while the human operator 50 continues to demonstrate the task via the glove 10.

Step S104 includes measuring the task characteristics (TC) using the glove 10 while the human operator 50 wears the glove 10 and demonstrates the task. The sensors 20, 30, and 40 collectively measure the task characteristics (TC) and transmit the signals describing the task characteristics, i.e., the forces F₁₀, palm pose O₁₇, and the joint configuration J₁₂, to the first controller 60. The method 100 continues with step S106.

At step S106, the first controller 60 may determine if the demonstration of the task is complete. Various approaches may be taken to implementing step S106, including detecting a home position or calibrated gesture or position of the glove 10, or detection of depression of a button (not shown) informing the first controller 60 that the demonstration of the task is complete. The method 100 then proceeds to step S108, which may be optionally informed by data collected at step S107.

Optional step S107 includes using the camera 38 of FIG. 3 to collect vision data, and thus the position signal (arrow P₅₀). If step S107 is used, the camera 38, e.g., a 3D point cloud camera or an optical scanner, can collect 3D positional information and determine, via the machine vision module (MVM), a relative position of the human operator 50, the glove 10, and/or other information and relay the same to the first controller 60.

Step S108 includes learning the demonstrated task from steps S102-S106. This entails processing the received task characteristics during or after completion of the demonstration via the machine learning (ML) module shown in FIG. 3. Step S108 may include generating task primitives, i.e., the core steps of the demonstrated task such as “grasp the light bulb 35 at point X₁Y₂Z₃ with force distribution X”, “move the grasped light bulb 35 to position X₂Y₁Z₂”, “insert the light bulb 35 into the socket at angle φ and velocity V”, “rotate light bulb 35 with torque T”, etc. Transitions between such task primitives may be detected by detecting changes in the values of the collected data from step S104. The method 100 proceeds to step S110 when the demonstrated task has been learned.

Step S110 includes translating the demonstrated task from step S108 into the task application file 85. Step S110 may include using the kinematics information K₁₀ and K₇₂ to translate the task as performed by the human operator 50 into machine readable and executable code suitable for the end-effector 72 shown in FIG. 3. For instance, because the high levels of dexterity of the human hand used by the human operator 50 of FIG. 3 can be, at best, only approximated by the machine hand that is the end-effector 72, it may not be possible to exactly duplicate, using the robot 70, the particular force distribution, pose, and joint configuration used by the human operator 50. Therefore, the first controller 60 is programmed to translate the demonstrated task into the closest approximation that is achievable by the end-effector 72, e.g., via transfer functions, lookup tables, or calibration factors. Instructions in a form that the second controller 80 can understand are then generated as the task application file 85. The method 100 proceeds to step S112 once the task application file 85 has been generated.

At step S112, the second controller 80 receives the task application file 85 from the first controller 60 and executes a control action with respect to the robot 70 of FIG. 3. In executing step S112, the second controller 80 transmits control signals (arrow CC₇₀) to the robot 70 describing the specific motion that is required. The robot 70 then moves the end-effector 72 according to the task application file 85 and thereby executes the demonstrated task, this time solely and automatically via operation of the robot 70.

While the best modes for carrying out the present disclosure have been described in detail, those familiar with the art to which this disclosure pertains will recognize various alternative designs and embodiments may exist that fall within the scope of the appended claims.

1. A system for demonstrating a task having force and position objectives to a robot, the system comprising:
a glove;
a plurality of sensors configured to collectively measure a set of task characteristics while a human operator wears the glove and demonstrates the task, wherein the set of task characteristics includes a pose, a joint angle configuration, and a distributed force of the glove; and
a controller in communication with the sensors that is programmed to:
receive the measured task characteristics from the sensors; and
apply machine learning logic to the received measured task characteristics to thereby learn and record the demonstrated task as a task application file.

2. The system of claim 1, wherein the controller is further programmed to generate a set of control signals using the task application file, and to transmit the set of control signals to the robot to thereby cause the robot to automatically perform the demonstrated task.

3. The system of claim 1, wherein the glove includes a palm and a plurality of fingers, and wherein the sensors that measure the distributed force of the glove include a plurality of force sensors arranged on the fingers and palm of the glove.

4. The system of claim 3, wherein the plurality of force sensors are piezo-resistive sensors.

5. The system of claim 3, wherein the plurality of fingers includes four fingers and an opposable thumb.

6. The system of claim 1, wherein the sensors that measure the joint angle configuration of the glove include a plurality of flexible conductive sensors each having a variable resistance corresponding to a different joint angle of the glove.

7. The system of claim 1, wherein the sensors that measure the pose of the glove include an inertial sensor.

8. The system of claim 1, wherein the sensors that measure the pose of the glove include a magnetic sensor.

9. The system of claim 1, wherein the sensors that measure the pose of the glove include an RFID device.

10. The system of claim 1, further comprising a camera operable for detecting a position of a target in the form of the operator, the operator's hands, or an object, wherein the first controller is programmed to receive the detected position as part of the set of task characteristics.

11. The system of claim 1, wherein the first controller is programmed with kinematics information of an end-effector of the glove and kinematics information of the glove, and is operable for calculating relative positions and orientations of the end-effector using the kinematics information of the end-effector and of the glove.

12. A method for demonstrating a task having force and position objectives to a robot using a glove on which is positioned a plurality of sensors configured to collectively measure a set of task characteristics, including a pose, a joint angle configuration, and a distributed force of the glove, the method comprising:
measuring the set of task characteristics using the glove while a human operator wears the glove and demonstrates the task;
transmitting the task characteristics to a controller; and
processing the task characteristics via the controller using machine learning logic to thereby learn and record the demonstrated task as a task application file.

13. The method of claim 12, further comprising:
generating a set of control signals via the controller using the task application file; and
transmitting the set of control signals from the controller to the robot to thereby cause the robot to automatically perform the demonstrated task.

14. The method of claim 12, wherein processing the task characteristics using machine learning logic includes generating task primitives defining core steps of the demonstrated task.

15. The method of claim 12, wherein the system includes a camera, and wherein the task characteristics include a relative position of the human operator or the glove and a point in a workspace.

16. The method of claim 12, wherein processing the task characteristics via the first controller using machine learning logic to thereby learn and record the demonstrated task includes translating the demonstrated task into machine readable and executable code using kinematics information describing kinematics of the glove.

17. The method of claim 12, wherein the glove includes a palm and a plurality of fingers, the sensors include a plurality of piezo-resistive force sensors arranged on the fingers and palm, and measuring the set of task characteristics includes measuring the distributed force using the piezo-resistive force sensors.

18. The method of claim 12, wherein the sensors include a plurality of flexible conductive sensors each having a variable resistance corresponding to a different joint angle of the glove, and wherein measuring the set of task characteristics includes measuring the joint angle configuration via the flexible conductive sensors.

19. The method of claim 12, wherein measuring the set of task characteristics includes measuring the pose of the glove via an inertial or a magnetic sensor.

20. The system of claim 12, wherein measuring the set of task characteristics includes measuring the pose of the glove via an RFID device.
